(19) United States
(12) Patent Application Publication
(10) Pub. No.: US 2023/0385581 A1
(43) Pub. Date: Nov. 30, 2023

(54) PAYMENT PROCESSING SYSTEM, DISPLAY APPARATUS, AND DISPLAY METHOD

(71) Applicant: KYOCERA Corporation, Kyoto (JP)

(72) Inventor: Shun SUGAHARA, Yokohama-shi, Kanagawa (JP)

(73) Assignee: KYOCERA Corporation, Kyoto (JP)

(21) Appl. No.: 18/250,305

(22) PCT Filed: Oct. 28, 2021
(86) PCT No.: PCT/JP2021/039918

§ 371 Date: Apr. 24, 2023

(30) Foreign Application Priority Data
Nov. 2, 2020 (JP) 2020-183749

(51) Int. Cl. G06K 7/14; G06Q 20/20

(52) U.S. Cl. CPC G06K 7/146; G06Q 20/208; G06K 7/1413; G06K 7/1417

(57) ABSTRACT

A payment processing system includes an imaging apparatus, a display apparatus, and a cash register. The imaging apparatus captures a first image in which an imaging target is captured. The display apparatus acquires the first image and displays a second image including identification information of the imaging target to an input unit of the cash register. The cash register specifies a type of the imaging target, based on the identification information. The second image is generated by object recognition processing or correction processing performed on the first image.

### CROSS-REFERENCE TO RELATED APPLICATIONS

This application claims the benefit of Japanese Patent Application No. 2020-183749, filed Nov. 2, 2020, the disclosure of which is incorporated herein by reference in its entirety.

### TECHNICAL FIELD

The present disclosure relates to a payment processing system, a display apparatus, and a display method.

### BACKGROUND OF INVENTION

For example, Patent Literature 1 discloses a self-cash register system in which a purchaser himself/herself can perform payment processing without intervention of an employee in a retail store or the like.

### CITATION LIST

### Patent Literature

Patent Literature 1: Japanese Unexamined Patent Publication No. 2016-194959

### SUMMARY

A payment processing system according to an aspect of the present disclosure includes an imaging apparatus, a display apparatus, and a cash register. The imaging apparatus captures a first image in which an imaging target is captured. The display apparatus acquires the first image and displays a second image including identification information of the imaging target to an input unit of the cash register. The cash register specifies a type of the imaging target, based on the identification information. The second image is generated by object recognition processing or correction processing performed on the first image.

A display apparatus according to an aspect of the present disclosure includes an input unit and an output unit. The input unit acquires a first image in which an imaging target is captured. The output unit performs display processing of displaying a second image including identification information of the imaging target to an input unit of a cash register. The second image is generated by object recognition processing or correction processing performed on the first image.

A display method according to an aspect of the present disclosure includes acquiring a first image in which an imaging target is captured, performing object recognition processing or correction processing on the first image, generating a second image including identification information of the imaging target, and displaying the second image to an input unit of a cash register.

A payment processing system according to an aspect of the present disclosure includes an object recognition apparatus, a display apparatus, and a cash register. The object recognition apparatus specifies an imaging target, based on a first image in which the imaging target is captured. The display apparatus displays a second image including identification information of the imaging target to an input unit of the cash register. The cash register specifies a type of the imaging target, based on the identification information.

### BRIEF DESCRIPTION OF THE DRAWINGS

FIG. 1 is a functional block diagram of a first embodiment of a payment processing system.

FIG. 2 is an external view of the first embodiment of the payment processing system.

FIG. 3 is a functional block diagram of a display apparatus included in the first embodiment of the payment processing system.

FIG. 4 illustrates an example of a barcode.

FIG. 5A illustrates an example of the barcode before performing rotation correction processing.

FIG. 5B illustrates an example of the barcode after performing rotation correction processing.

FIG. 6A illustrates an example of the barcode before performing regeneration correction processing.

FIG. 6B illustrates an example of the barcode after performing regeneration correction processing.

FIG. 7 is a flowchart related to a process for specifying an imaging target in the first embodiment of the payment processing system.

FIG. 8 is a functional block diagram of a second embodiment of the payment processing system.

FIG. 9 is an external view of the second embodiment of the payment processing system.

FIG. 10 is a functional block diagram of a display apparatus included in the second embodiment of the payment processing system.

FIG. 11 is a flowchart related to a process for specifying an imaging target in the second embodiment of the payment processing system.

FIG. 12 is a functional block diagram of a third embodiment of the payment processing system.

FIG. 13 is a flowchart related to a process for specifying an imaging target in the third embodiment of the payment processing system.

### DESCRIPTION OF EMBODIMENTS

If a self-cash register system such as that disclosed in Patent Literature 1 is introduced, replacement with an existing cash register system is often accompanied. Considering the cost of capital investment, it is desirable to introduce a self-cash register system without replacing the existing cash register system. According to the present disclosure, it is possible to construct a self-cash register system that is connected to the existing cash register system.

Hereinafter, embodiments of a payment processing system and a display apparatus to which the present disclosure is applied will be described with reference to the drawings.

### First Embodiment

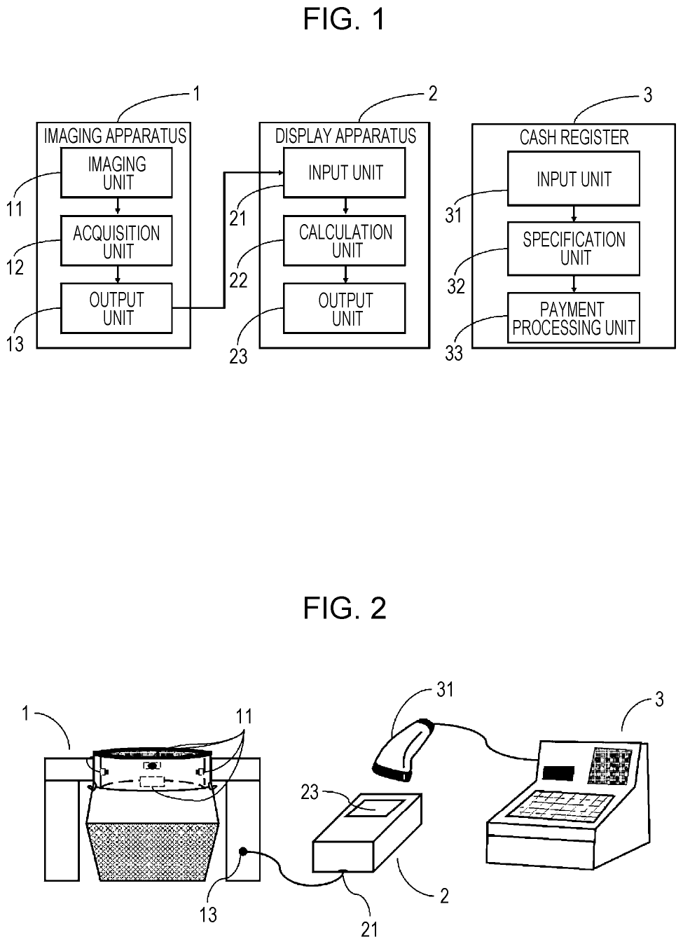

FIGS. 1 and 2 are a functional block diagram and an external view, respectively, of a first embodiment of a payment processing system.

As illustrated in FIG. 1, the payment processing system according to the first embodiment of the present disclosure includes an imaging apparatus 1, a display apparatus 2, and a cash register 3.

In the following figures, a solid arrow connecting functional blocks indicates a flow of a control signal or communicated information. The communication indicated by the solid arrow may be wired communication, wireless communication, or a combination of both. If communication is performed wirelessly, the imaging apparatus 1, the display apparatus 2, or the cash register 3 may include a communication module for performing wireless communication conforming to various communication standards including Bluetooth (registered trademark) and IEEE802.11, for example. The wireless communication may be optical communication.

In the following drawings, a broken arrow connecting functional blocks indicates a flow of information in which, for example, information of a functional block positioned on a start point side of the arrow is acquired by a functional block positioned on an end point side. The flow of information indicated by the broken arrow may be, for example, a flow of image analysis.

The imaging apparatus 1 includes an imaging unit 11, an acquisition unit 12, and an output unit 13.

The imaging unit 11 captures an image of an imaging target and generates a first image in which the imaging target is captured. In other words, the first image can be referred to as a captured image.

The imaging unit 11 includes an imaging optical system and an imaging element. The imaging optical system includes optical members such as one or more lenses and a diaphragm, for example. Any lens may be used regardless of the focal length. For example, the lens may be a general lens, a wide-angle lens including a fish-eye lens, or a zoom lens having a variable focal length. The imaging optical system forms a subject image on a light receiving surface of the imaging element. The imaging element includes, for example, a CCD (Charge Coupled Device) image sensor or a CMOS (Complementary Metal-Oxide Semiconductor) image sensor. The imaging element captures the subject image formed on the light receiving surface to generate the captured image. The imaging unit 11 may continuously capture still images at any frame rate. Continuously capturing still images can be referred to as capturing a moving image.

The acquisition unit 12 extracts identification information for specifying the type of the imaging target from the first image captured by the imaging unit 11. The acquisition unit 12 acquires the identification information by extracting the identification information.

The identification information may be, for example, a one dimensional barcode including a JAN (Japan Article Number) code or a two dimensional barcode including a QR code (registered trademark). In general, by using the identification information, it is possible to specify a product name or price of the imaging target, and to perform payment processing, sales management, inventory purchase management, and the like.

The acquisition unit 12 may use, for example, an object recognition method based on pattern matching or machine learning to extract the identification information. As the object recognition method for extracting the identification information, the acquisition unit 12 may use a known method such as Detection Network or Sliding Window Detection.

In order for the acquisition unit 12 to extract the identification information, the acquisition unit 12 may generate a new image by performing trimming processing so as to include the identification information from the first image, for example.

The acquisition unit 12 includes a processor and a memory. The processor may include a CPU (Central Processing Unit), a GPU (Graphics Processing Unit), a FPGA (Field-Programmable Gate Array), or the like. The memory may include a semiconductor memory, a magnetic memory, an optical memory, or the like. The semiconductor memory may include a volatile memory or a non-volatile memory. The magnetic memory may include, for example, a hard disk or a magnetic tape. The optical memory may include, for example, a CD (Compact Disc), a DVD (Digital Versatile Disc), or a BD (Blu-ray (registered trademark) Disc).

The memory included in the acquisition unit 12 may store various kinds of information or parameters related to the operation of the imaging apparatus 1. The memory may store a program to be executed by the acquisition unit 12. The memory may function as a work memory of the acquisition unit 12. The memory may store the first image, the identification information, or the like.

The output unit 13 outputs the identification information acquired by the acquisition unit 12 to an input unit 21 included in the display apparatus 2.

Although FIG. 2 illustrates an example in which wired communication is performed by establishing wired connection between the output unit 13 and the input unit 21, wireless communication may be performed between the output unit 13 and the input unit 21 as described in paragraph [0014].

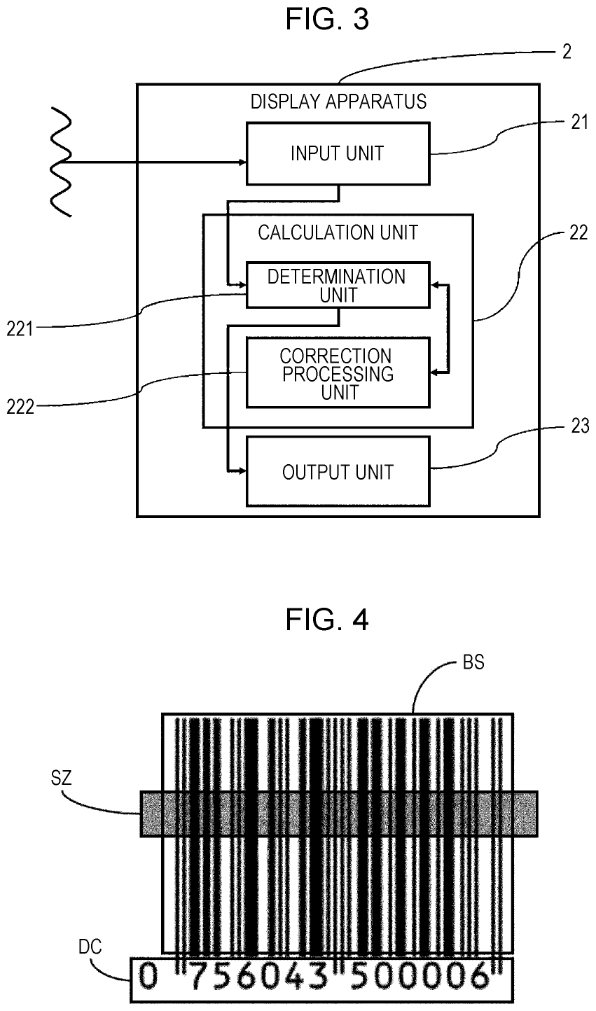

FIG. 3 is a functional block diagram of the display apparatus 2 included in the first embodiment of the payment processing system.

The display apparatus 2 includes the input unit 21, a calculation unit 22, and an output unit 23.

The input unit 21 receives input of identification information output by the output unit 13 included in the imaging apparatus 1.

As illustrated in FIG. 3, the calculation unit 22 includes a determination unit 221 and a correction processing unit 222.

The calculation unit 22 includes a processor and a memory. The processor may include a CPU (Central Processing Unit), a GPU (Graphics Processing Unit), a FPGA (Field-Programmable Gate Array), or the like. The memory may include a semiconductor memory, a magnetic memory, an optical memory, or the like. The semiconductor memory may include a volatile memory or a non-volatile memory. The magnetic memory may include, for example, a hard disk or a magnetic tape. The optical memory may include, for example, a CD (Compact Disc), a DVD (Digital Versatile Disc), or a BD (Blu-ray (registered trademark) Disc).

The memory included in the calculation unit 22 may store various kinds of information or parameters related to the operation of the display apparatus 2. The memory may store a program to be executed by the calculation unit 22. The memory may function as a work memory of the calculation unit 22. The memory may store the first image, the identification information, or the like.

The determination unit 221 determines whether the identification information received by the input unit 21 satisfies a predetermined condition.

The predetermined condition may be, for example, that an input unit 31 included in the cash register 3, which will be described later, detects the identification information and can specify the imaging target. In other words, it may be determined whether correction processing on the identification information by the correction processing unit 222 is necessary. In other words, if the determination unit 221 determines that it is not possible to specify the imaging target by the identification information detected by the input unit 31, the identification information does not satisfy the predetermined condition.

If the determination unit 221 determines that the identification information satisfies the predetermined condition, the determination unit 221 outputs the identification information as a second image. Before outputting the second image, the determination unit 221 may perform trimming processing or correction processing such as rearrangement of the identification information on the identification information so that the input unit 31 can easily read the identification information. That is, the identification information may be depicted or present in the second image.

If the determination unit 221 does not determine that the identification information satisfies the predetermined condition, that is, if the determination unit 221 determines that the correction processing by the correction processing unit 222 is necessary for the identification information, the correction processing unit 222 performs the correction processing on the identification information so as to satisfy the predetermined condition.

The correction processing unit 222 performs, for example, any one of rotation correction, distortion correction, contrast correction, edge correction, and regeneration correction as the correction processing on the identification information to generate corrected identification information.

With reference to FIGS. 4 to 6, the correction processing performed by the correction processing unit 222 will be described on the assumption that the identification information is a one dimensional barcode.

FIG. 4 illustrates an example used for describing the configuration of the identification information.

As illustrated in FIG. 4, a one dimensional barcode generally includes a barcode symbol BS and a data character DC. However, the data character DC may be absent in a two dimensional barcode or the like.

The barcode symbol BS consists of an array of parallel rectangular bars or spaces having a high optical reflectivity portion and a low optical reflectivity portion and having different widths, and is coded to be readable by a machine. The barcode symbol BS is configured by a combination of four types of narrow bars which are thin bars, wide bars which are thick bars, narrow spaces which are thin spaces, and wide spaces which are thick spaces, based on a given standard such as a JAN code. A barcode reader included in the cash register can specify an object by reading the barcode symbol BS through a scan zone SZ which is a scan area of the barcode reader. Except for a two dimensional barcode or the like, both ends of the barcode symbol BS in the longitudinal direction are adjacent to a space called a quiet zone. If the scan zone SZ includes quiet zones adjacent to both ends of the barcode symbol BS in the longitudinal direction, it can be said that both ends of the barcode symbol BS in the longitudinal direction are appropriately included in the scan zone SZ.

The data character DC is a character/digit string encoded in the barcode symbol BS. In other words, it can be said that the barcode symbol BS is obtained by encoding a character/digit string described in the data character DC, based on a given standard.

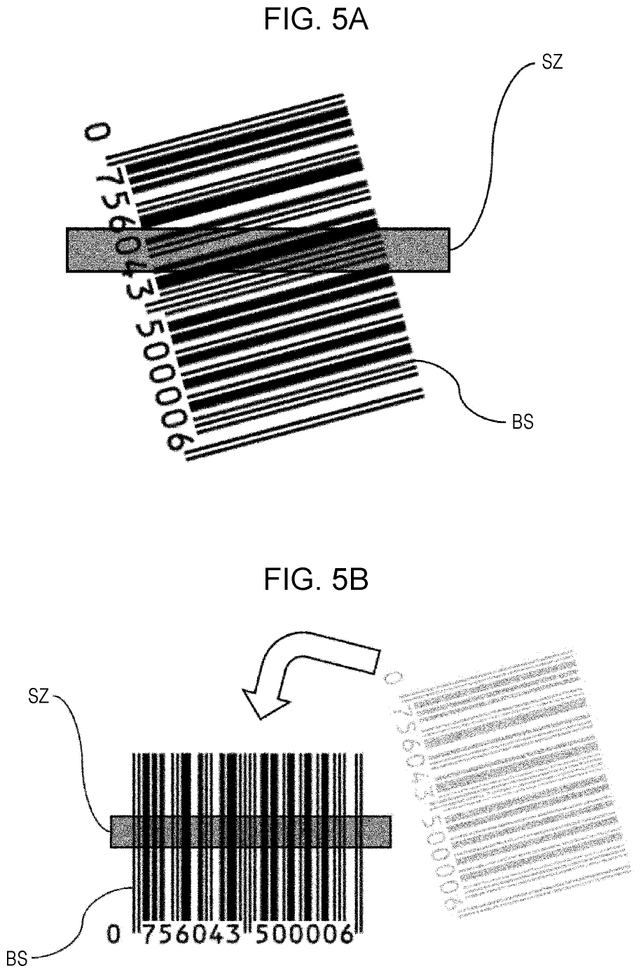

FIG. 5A illustrates an example of a state in which the identification information is inclined.

As illustrated in FIG. 5A, if the identification information is input to the determination unit 221 in an inclined state, for example, the barcode symbol BS may fail to be appropriately included in the scan zone SZ. In this case, the determination unit 221 determines that the identification information does not satisfy the predetermined condition, and determines that the correction processing unit 222 needs to perform rotation correction processing on the identification information.

The determination unit 221 may determine whether the correction processing unit 222 needs to perform the rotation correction processing on the identification information, based on whether both ends of the barcode symbol BS are included in the scan zone SZ, for example. That is, if the determination unit 221 determines that both ends of the barcode symbol BS are not included in the scan zone SZ, the correction processing unit 222 may perform the rotation correction processing on the identification information.

FIG. 5B illustrates an example of the rotation correction processing for the inclined identification information.

If the determination unit 221 determines that the correction processing unit 222 needs to perform the rotation correction processing on the identification information, the correction processing unit 222 performs the rotation correction processing on the identification information as illustrated in FIG. 5B. In the example in FIG. 5B, the inclined identification information illustrated transparently is rotated counterclockwise as viewed from the front of the drawing, and the rotation correction processing is performed so that the barcode symbol SB is included in the scan zone SZ.

As a method for determining that the correction processing unit 222 needs to perform the rotation correction processing on the identification information, for example, a rotation correction method using machine learning or a most frequent angle may be used. As a rotation correction method using machine learning, for example, a method may be used in which deep learning is applied by learning a CNN (Convolutional Neural Network) in a form in which an image including the identification information that is rotated n degrees as a rotation angle is input and regresses n degrees. As an internal process of the rotation correction method using the most frequent angle, a process may be used in which the angle of the identification information in the first image is estimated by detecting straight lines by Hough transform or the like, estimating the angle of each straight line, and obtaining the mode of the estimated angle of each straight line, focusing on the fact that the identification information including a one dimensional barcode or a two dimensional barcode includes a plurality of parallel lines.

If the identification information is input to the determination unit 221 with distortion, for example, the barcode symbol BS may fail to be appropriately included in the scan zone SZ. In this case, the determination unit 221 determines that the identification information does not satisfy the predetermined condition, and determines that the correction processing unit 222 needs to perform distortion correction processing on the identification information.

The determination unit 221 may determine whether the correction processing unit 222 needs to perform the distortion correction processing on the identification information, for example, based on whether shape information obtained from start points and end points of narrow bars or wide bars included in the identification information is uniform. That is, if the determination unit 221 determines that the shape information of the identification information is not uniform, the correction processing unit 222 may perform the distortion correction processing on the identification information.

The distortion correction processing may include, for example, performing matrix conversion so that the shape information becomes uniform.

If the identification information is input to the determination unit 221 in an unclear state, for example, the barcode symbol BS may fail to be appropriately included in the scan zone SZ. In this case, the determination unit 221 determines that the identification information does not satisfy the predetermined condition, and determines that the correction processing unit 222 needs to perform contrast correction processing on the identification information.

The determination unit 221 may determine whether the correction processing unit 222 needs to perform the contrast correction processing on the identification information, based on, for example, a ratio or difference in luminance between a bar portion and a space portion. That is, if the determination unit 221 determines that the ratio or difference in luminance is less than or equal to a predetermined threshold, the correction processing unit 222 may perform the contrast correction processing on the identification information.

The contrast correction processing may include, for example, either changing a gamma value or binary conversion processing of an image.

If the identification information is input to the determination unit 221 with blurring of the subject, for example, the barcode symbol BS may fail to be appropriately included in the scan zone SZ. In this case, the determination unit 221 determines that the identification information does not satisfy the predetermined condition, and determines that the correction processing unit 222 needs to perform edge correction processing on the identification information.

The determination unit 221 may determine whether the correction processing unit 222 needs to perform the edge correction processing on the identification information, based on, for example, a spatial frequency of a boundary portion between the bar portion and the space portion between a narrow bar/wide bar and a narrow space/wide space. That is, if the determination unit 221 determines that the number of spaces is less than or equal to a predetermined threshold, the correction processing unit 222 may perform the edge correction processing on the identification information.

The edge correction processing may include, for example, either emphasizing the edge or binary conversion processing of an image. In addition, high-resolution processing may be performed in the edge correction processing.

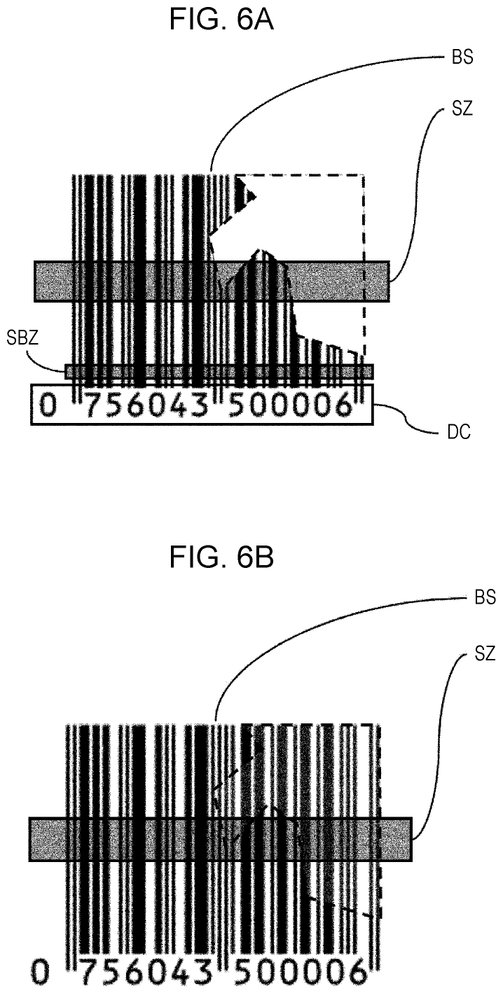

FIG. 6A illustrates an example of partially lost identification information.

As illustrated in FIG. 6A, if the identification information is input to the determination unit 221 in the partially lost state, for example, the barcode symbol BS may fail to be appropriately included in the scan zone SZ. In this case, the determination unit 221 determines that the identification information does not satisfy the predetermined condition, and determines that the correction processing unit 222 needs to perform regeneration correction processing on the identification information.

The determination unit 221 may determine whether the correction processing unit 222 needs to perform the regeneration correction processing on the identification information, based on, for example, determination that the rotation correction, the distortion correction, the contrast correction, or the edge correction is unsuitable. That is, if the determination unit 221 determines that the identification information does not satisfy the predetermined condition and does not satisfy the conditions of the rotation correction, the distortion correction, the contrast correction, or the edge correction, the correction processing unit 222 may perform the regeneration correction processing on the identification information.

FIG. 6B illustrates an example of the regeneration correction processing for the partially lost identification information.

If the determination unit 221 determines that the correction processing unit 222 needs to perform the regeneration correction processing on the identification information, the correction processing unit 222 performs the regeneration correction processing on the identification information as illustrated in FIG. 6B. In the example illustrated in FIG. 6B, the correction processing unit 222 detects a readable zone SBZ of the barcode symbol BS which is not lost, or the data character DC, from the partially lost identification information, and performs the regeneration correction processing for generating new identification information based on the detected readable zone SBZ or data character DC.

The correction processing unit 222 may perform correction processing by combining any two or more of the correction processing methods including the rotation correction, the distortion correction, the contrast correction, the edge correction, and the regeneration correction described above. Note that a known method other than those described above may be used as the correction processing method.

The determination unit 221 may determine whether the corrected identification information generated by the correction processing unit 222 satisfies the predetermined condition. If the determination unit 221 determines that the corrected identification information satisfies the predetermined condition, the determination unit 221 generates the second image, based on the corrected identification information.

The output unit 23 displays the second image to the input unit 31 included in the cash register 3, which will be described later, as illustrated in FIG. 2.

The output unit 23 includes a display device such as a liquid crystal display, an organic EL (Emitting Diode) display, or an inorganic EL display.

The cash register 3 includes the input unit 31, a specification unit 32, and a payment processing unit 33.

The input unit 31 analyzes the second image displayed by the output unit 23 included in the display apparatus 2, and acquires specification information to be used for specifying the type of the imaging target.

The input unit 31 may be, for example, an optical reader. The optical reader may be, for example, any one of a pen reader, a CCD touch reader, a laser scanner, a two dimensional barcode reader, or a stationary barcode reader.

The specification unit 32 specifies the imaging target based on the specification information acquired by the input unit 31. Specifying the imaging target includes specifying a product name or price of the imaging target.

The payment processing unit 33 performs payment processing, based on the product name or price of the imaging target specified by the specification unit 32. The payment processing may be, for example, calculating a total price of one or more imaging targets specified by the specification unit 32.

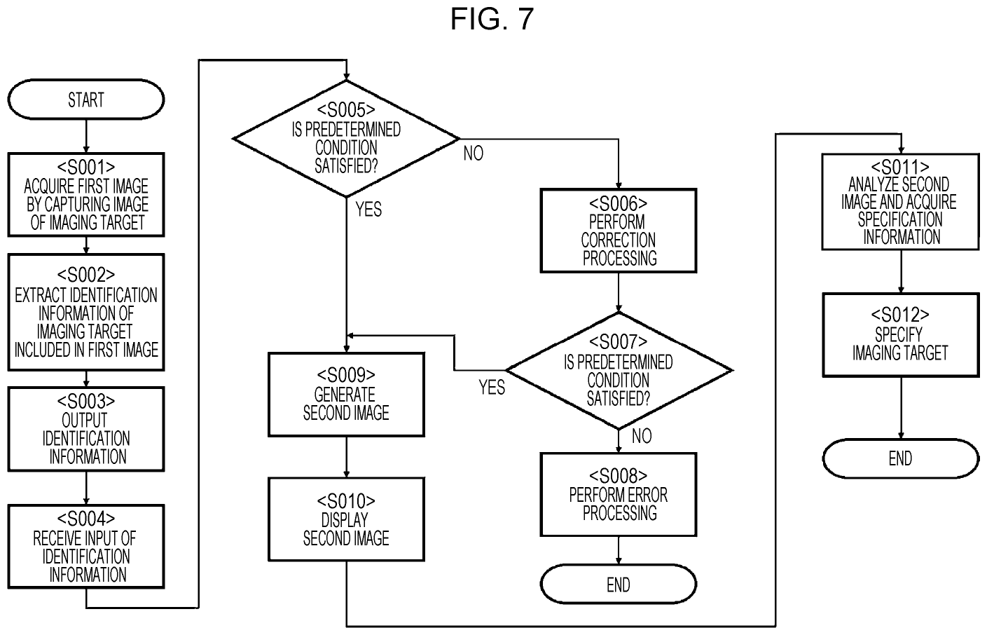

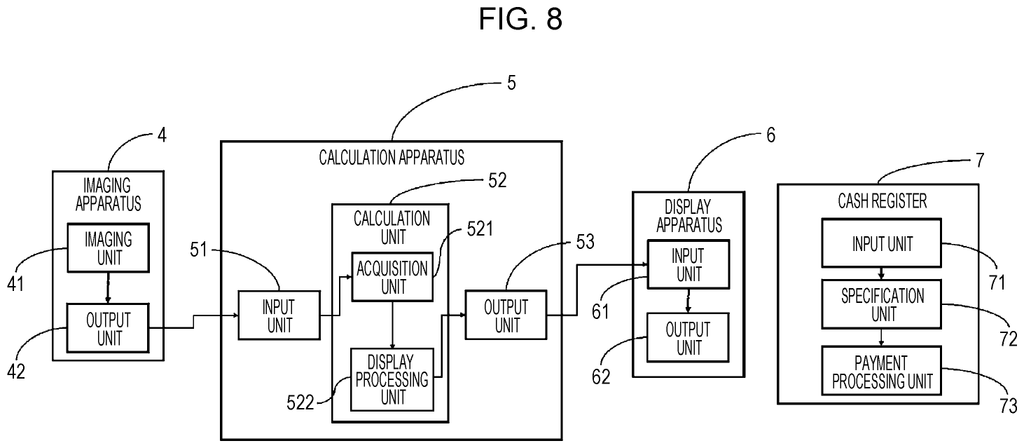

Next, a process flow for specifying an imaging target in the first embodiment of the payment processing system will be described with reference to FIG. 7.

<S001> The imaging unit 11 included in the imaging apparatus 1 acquires a first image by capturing an image of an imaging target. The process then proceeds to <S002>.

<S002> After the imaging unit 11 acquires the first image, the acquisition unit 12 extracts identification information from the first image. The process then proceeds to <S003>.

<S003> After the acquisition unit 12 extracts the identification information, the output unit 13 outputs the identification information to the input unit 21 included in the display apparatus 2. The process then proceeds to <S004>.

<S004> After the output unit 13 outputs the identification information, the input unit 21 receives input of the identification information. The process then proceeds to <S005>.

<S005> After the input unit 21 receives the input of the identification information, the determination unit 221 included in the calculation unit 22 determines whether the identification information satisfies a predetermined condition. If the determination unit 221 determines that the identification information satisfies the predetermined condition, the process proceeds to <S009>. If the determination unit 221 does not determine that the identification information satisfies the predetermined condition, the process proceeds to <S006>.

<S006> If the determination unit 221 does not determine that the identification information satisfies the predetermined condition, the correction processing unit 222 performs correction processing to generate corrected identification information. The process then proceeds to <S007>.

<S007> After the correction processing unit 222 performs the correction processing to generate the corrected identification information, the determination unit 221 determines whether the corrected identification information satisfies the predetermined condition. If the determination unit 221 determines that the corrected identification information satisfies the predetermined condition, the process proceeds to <S009>. If the determination unit 221 determines that the corrected identification information does not satisfy the predetermined condition, the process proceeds to <S008>.

<S008> If the determination unit 221 determines that the corrected identification information does not satisfy the predetermined condition, the determination unit 221 performs error processing. Then, this process flow for specification ends.

The error processing may be a notification to a user or an employee, for example. The notification to the user or the employee may be, for example, an error notification on a display, an error notification by voice, or a notification related to the occurrence of an error to a separately installed management system or the like. In this case, the display apparatus 2 may include a display, a speaker, or a communication module for performing the error processing.

<S009> If the determination unit 221 determines that the identification information or the corrected identification information satisfies the predetermined condition, the determination unit 221 generates the second image, based on the identification information or the corrected identification information. The process then proceeds to <S010>.

<S010> After the determination unit 221 generates the second image, the output unit 23 displays the second image. The process then proceeds to <S011>.

<S011> After the output unit 23 displays the second image, the input unit 31 included in the cash register 3 analyzes the second image displayed on the output unit 23 and acquires specification information to be used for the type of the imaging target. The process then proceeds to <S012>.

<S012> After the input unit 31 acquires the specification information to be used for the type of the imaging target, the specification unit 32 specifies the type of the imaging target, based on the specification information. Then, this process flow for specification ends.

### Second Embodiment

In the first embodiment, each of the acquisition unit 12 included in the imaging apparatus 1 and the calculation unit 22 included in the display apparatus 2 performs calculation processing. On the other hand, the calculation processing can be performed by an external computational resource, such as a central server. That is, in a second embodiment of the payment processing system, the calculation processing is performed by an external computational resource.

Note that in the second and a subsequent embodiment, differences from the first embodiment will be predominantly described. That is, a description overlapping with the above-described embodiment may be omitted.

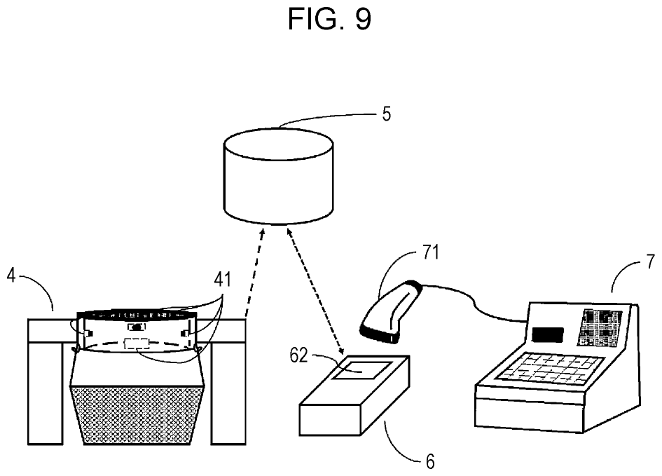

FIGS. 8 and 9 are a functional block diagram and an external view, respectively, of the second embodiment of the payment processing system.

As illustrated in FIGS. 8 and 9, the payment processing system according to the second embodiment of the present disclosure includes an imaging apparatus 4, a calculation apparatus 5, a display apparatus 6, and a cash register 7.

The imaging apparatus 4 includes an imaging unit 41 and an output unit 42.

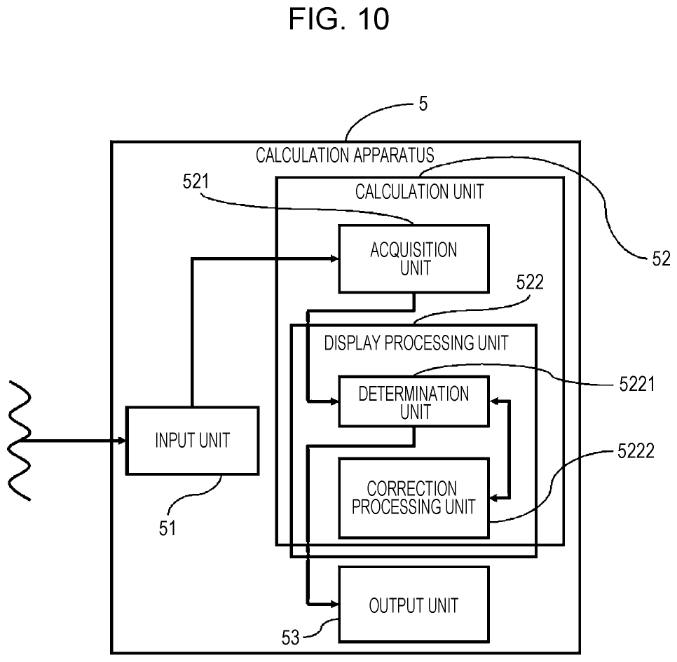

FIG. 10 is a functional block diagram of the calculation apparatus 5 included in the second embodiment of the payment processing system.

The calculation apparatus 5 includes an input unit 51, a calculation unit 52, and an output unit 53.

The input unit 51 receives input of a first image output by the output unit 42 included in the imaging apparatus 4.

As illustrated in FIG. 10, the calculation unit 52 includes an acquisition unit 521 and a display processing unit 522. Furthermore, the display processing unit 522 includes a determination unit 5221 and a correction processing unit 5222.

The acquisition unit 521 extracts identification information for specifying the type of an imaging target from the first image whose input is received by the input unit 51. The acquisition unit 521 acquires the identification information by extracting the identification information.

The determination unit 5221 determines whether the identification information acquired by the acquisition unit 521 satisfies a predetermined condition.

If the determination unit 5221 does not determine that the identification information satisfies the predetermined condition, that is, if the determination unit 5221 determines that correction processing by the correction processing unit 5222 is necessary, the correction processing unit 5222 performs the correction processing on the identification information so as to satisfy the predetermined condition.

The correction processing unit 5222 performs the correction processing on the identification information to generate corrected identification information.

The output unit 53 outputs, as a second image, the identification information or the corrected identification information generated by the calculation unit 52 to an input unit 61 included in the display apparatus 6.

The display apparatus 6 includes the input unit 61 and an output unit 62.

The input unit 61 receives input of the second image from the output unit 53 included in the calculation apparatus 5.

The output unit 62 displays the second image whose input is received by the input unit 61 to an input unit 71 included in the cash register 7 as illustrated in FIG. 9.

The cash register 7 includes the input unit 71, a specification unit 72, and a payment processing unit 73.

Since the cash register 7 may be the same as the cash register 3 described in the first embodiment, a description thereof will be omitted.

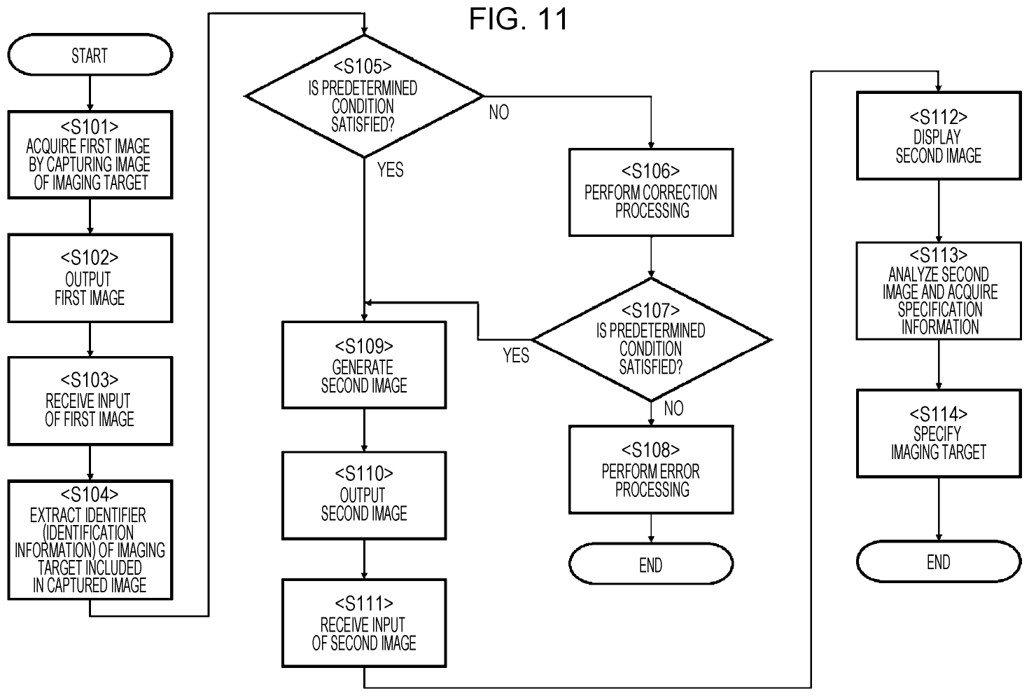

Next, a process flow for specifying an imaging target in the second embodiment of the payment processing system will be described with reference to FIG. 11.

<S101> The imaging unit 41 included in the imaging apparatus 4 acquires a first image by capturing an image of an imaging target. The process then proceeds to <S102>.

<S102> After the imaging unit 41 acquires the first image, the output unit 42 outputs the first image to the input unit 51 included in the calculation apparatus 5. The process then proceeds to <S103>.

<S103> After the output unit 42 outputs the first image, the input unit 51 receives input of the first image. The process then proceeds to <S104>.

<S104> After the input unit 51 receives the input of the first image, the acquisition unit 521 extracts identification information from the first image. The process then proceeds to <S105>.

<S105> After the acquisition unit 521 extracts the identification information, the determination unit 5221 included in the display processing unit 522 determines whether the identification information satisfies a predetermined condition. If the determination unit 5221 determines that the identification information satisfies the predetermined condition, the process proceeds to <S109>. If the determination unit 5221 does not determine that the identification information satisfies the predetermined condition, the process proceeds to <S106>.

<S106> If the determination unit 5221 determines that the identification information does not satisfy the predetermined condition, the correction processing unit 5222 performs correction processing to generate corrected identification information. The process then proceeds to <S107>.

<S107> After the correction processing unit 5222 performs the correction processing to generate the corrected identification information, the determination unit 5221 determines whether the corrected identification information satisfies the predetermined condition. If the determination unit 5221 determines that the corrected identification information satisfies the predetermined condition, the process proceeds to <S109>. If the determination unit 5221 determines that the corrected identification information does not satisfy the predetermined condition, the process proceeds to <S108>.

<S108> If the determination unit 5221 determines that the corrected identification information does not satisfy the predetermined condition, the determination unit 5221 performs error processing. Then, this process flow for specification ends.

<S109> If the determination unit 5221 determines that the identification information or the corrected identification information satisfies the predetermined condition, the determination unit 5221 generates a second image, based on the identification information or the corrected identification information. The process then proceeds to <S110>.

<S110> After the determination unit 5221 generates the second image, the output unit 53 outputs the second image to the input unit 61 included in the display apparatus 6. The process then proceeds to <S111>.

<S111> After the output unit 53 outputs the second image, the input unit 61 receives input of the second image. The process then proceeds to <S112>.

<S112> After the input unit 61 receives the input of the second image, the output unit 62 displays the second image. The process then proceeds to <S113>.

<S113> After the output unit 62 displays the second image, the input unit 71 included in the cash register 7 analyzes the second image displayed on the output unit 62 and acquires specification information to be used for specifying the type of the imaging target. The process then proceeds to <S114>.

<S114> After the input unit 71 acquires the specification information to be used for specifying the type of the imaging target, the specification unit 72 specifies the type of the imaging target, based on the specification information. Then, this process flow for specification ends.

### Third Embodiment

In the first embodiment and the second embodiment, the type of the imaging target is not specified in the calculation processing in the imaging apparatuses 1 and 4, the calculation apparatus 5, and the display apparatuses 2 and 6. On the other hand, it is also possible to use a known object recognition technology represented by, for example, a DNN (Deep Neural Network) and pattern matching to specify the imaging target before inputting information to the cash register 3. That is, in a third embodiment of the payment processing system, the imaging target is specified before inputting information to the cash register.

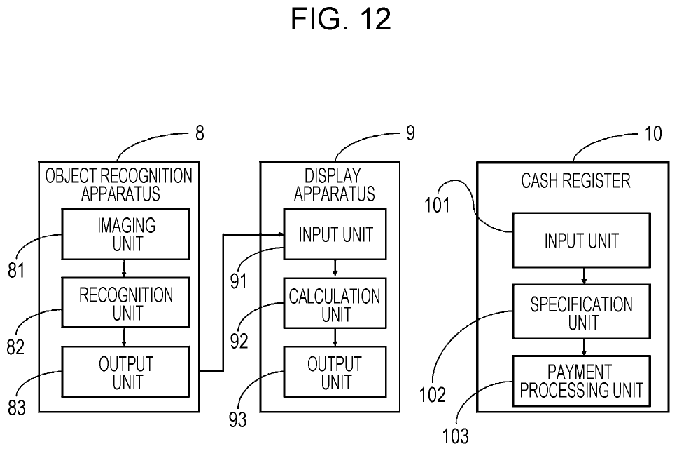

FIG. 12 is a functional block diagram of the third embodiment of the payment processing system.

As illustrated in FIG. 12, the payment processing system according to the third embodiment of the present disclosure includes an object recognition apparatus 8, a display apparatus 9, and a cash register 10.

The object recognition apparatus 8 includes an imaging unit 81, a recognition unit 82, and an output unit 83.

The recognition unit 82 performs object recognition processing, based on the first image generated by the imaging unit 81, and specifies the type of the imaging target captured in the first image. Then, the recognition unit 82 generates a recognition result that is information related to the type of the imaging target. It can be said that the recognition result corresponds to the identification information in the first embodiment and the second embodiment.

The recognition result may be, for example, an ID using the type of the imaging target as a key. In other words, the recognition result may be any information as long as the information is necessary for the display apparatus 9 described below to generate a second image that can be analyzed by an input unit 101 included in the cash register 10.

The recognition unit 82 includes a processor and a memory in the same manner as the acquisition unit 12 included in the imaging apparatus 1 according to the first embodiment.

The output unit 83 outputs the recognition result generated by the recognition unit 82 to an input unit 91 included in the display apparatus 9.

The display apparatus 9 includes the input unit 91, a calculation unit 92, and an output unit 93.

The input unit 91 receives input of the recognition result output by the output unit 83 included in the object recognition apparatus 8.

The calculation unit 92 generates the second image, based on the recognition result received by the input unit 91.

For example, the calculation unit 92 may generate the second image by a method according to regeneration correction processing which is a kind of correction processing. That is, the calculation unit 92 may generate a one dimensional barcode or a two dimensional barcode corresponding to the recognition result as the second image. In this case, the display apparatus 9 may communicate with a separately installed data server. The data server may include a database in which the type of the imaging target is associated with the identification information. That is, the calculation unit 92 may inquire of the data server about the recognition result, and acquire the one dimensional barcode or the two dimensional barcode corresponding to the specified type of the imaging target before generating the second image.

The output unit 93 displays the second image generated by the calculation unit 92 to the input unit 101 included in the cash register 10.

The cash register 10 includes the input unit 101, a specification unit 102, and a payment processing unit 103.

Since the cash register 10 may be the same as the cash register 10 described in the first embodiment, a description thereof will be omitted.

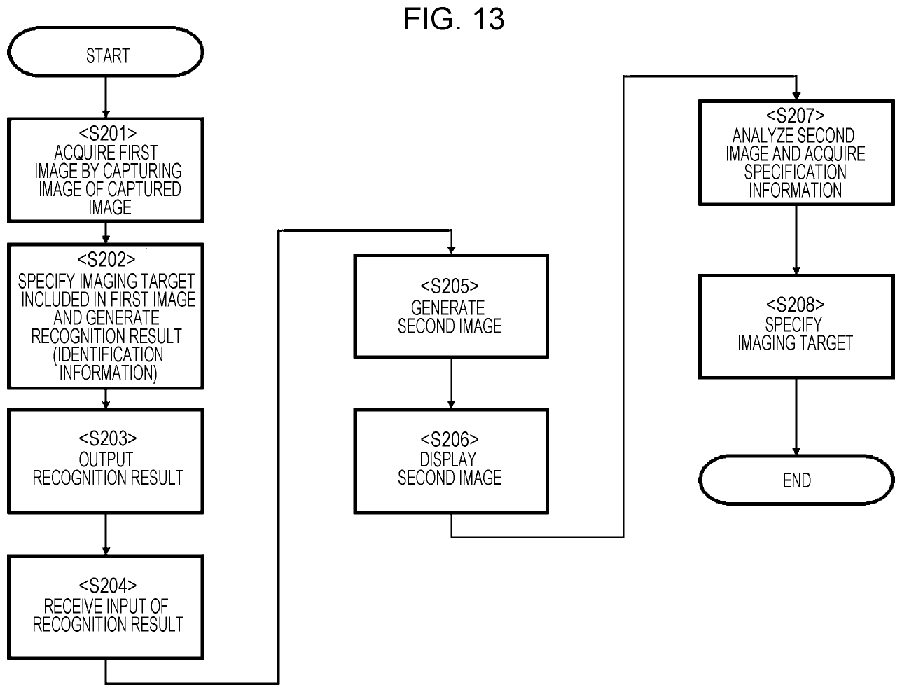

Next, a process flow for specifying an imaging target in the third embodiment of the payment processing system will be described with reference to the flowchart in FIG. 13.

<S201> The imaging unit 81 included in the object recognition apparatus 8 acquires a first image by capturing an image of an imaging target. The process then proceeds to <S202>.

<S202> After the imaging unit 81 acquires the first image, the recognition unit 82 specifies the type of the imaging target captured in the first image and generates a recognition result. The process then proceeds to <S203>.

<S203> After the recognition unit 82 generates the recognition result, the output unit 83 outputs the recognition result to the input unit 91 included in the display apparatus 9. The process then proceeds to <S204>.

<S204> After the output unit 83 outputs the recognition result, the input unit 91 receives input of the recognition result. The process then proceeds to <S205>.

<S205> After the input unit 91 receives the input of the recognition result, the calculation unit 92 generates a second image, based on the recognition result. The process then proceeds to <S206>.

<S206> After the calculation unit 92 generates the second image, the output unit 93 displays the second image. The process then proceeds to <S207>.

<S207> After the output unit 93 displays the second image, the input unit 101 included in the cash register 10 analyzes the second image displayed on the output unit 93 and acquires specification information to be used for specifying the type of the imaging target. The process then proceeds to <S208>.

<S208> After the input unit 101 acquires the specification information to be used for specifying the type of the imaging target, the specification unit 102 specifies the type of the imaging target, based on the specification information. Then, this process flow for specification ends.

As for an image registration system, the present disclosure has been described based on the drawings and the embodiments. However, it is to be noted that those skilled in the art can easily make various changes and variations based on the present disclosure.

For example, functions, means, steps, and the like described in the embodiments may be rearranged without logical contradiction, and a plurality of means, steps, and the like may be combined into one or divided.

In addition, it is considered that two or more first images are acquired by using two or more imaging optical systems included in the imaging units 11, 41, and 81 or by continuously capturing still images. In this case, in order to acquire the identification information or the recognition result, the acquisition unit 12, the calculation unit 52, or the recognition unit 82 may perform processing such as selection or combination on the two or more first images to generate the identification information, or may perform object recognition processing on an image generated by performing the processing such as selection or combination.

In addition, the acquisition unit 12, the calculation unit 52, or the recognition unit 82 may fail to extract or acquire the identification information or the recognition result. In this case, the acquisition unit 12, the calculation unit 52, or the recognition unit 82 may perform error processing. As the error processing, for example, the processing described in paragraph or the like may be performed.

In addition, if the correction processing unit 222 or 5222 performs the correction process to generate the corrected identification information and then the determination unit 221 or 5221 determines that the corrected identification information does not satisfy the predetermined condition, the determination unit 221 or 5221 may perform the correction process again on the corrected identification information. That is, with reference to the flowchart in FIG. 7 as an example, if processing in <S007> results in NO, the process may return to <S006> instead of proceeding to <S008>.

In addition, when performing the correction processing again on the corrected identification information, the determination unit 221 or 5221 may determine which correction processing is to be performed again.

In addition, when performing the correction processing again on the corrected identification information, the determination unit 221 or 5221 may provide a predetermined threshold for the number of times of performing the correction processing. For example, if the determination unit 221 or 5221 determines that the corrected identification information does not satisfy the predetermined condition, the determination unit 221 or 5221 may perform the error processing without performing the correction processing again.

In addition, in the third embodiment, it has been described in paragraph that the calculation unit 92 may generate, as the second image, the identification information including the one dimensional barcode or the two dimensional barcode corresponding to the recognition result. However, the recognition unit 82 included in the object recognition apparatus 8 may perform this processing. That is, the recognition unit 82 may generate, as the second image, the one dimensional barcode or the two dimensional barcode corresponding to the recognition result, and may communicate with a data server installed separately from the object recognition apparatus 8. Thus, the recognition unit 82 may introduce the recognition result to the data server, and acquire the corresponding one dimensional barcode or two dimensional barcode before generating the second image.

In addition, in the third embodiment, it is described in paragraph that the calculation unit 92 may inquire of the data server about the recognition result, and acquire the one dimensional barcode or the two dimensional barcode corresponding to the specified type of the imaging target before generating the second image. However, the following method may be employed as a substitute. The calculation unit 92 may inquire of the data server about the recognition result, and acquire the data character DC corresponding to the specified type of the imaging target, and, as in the method described in paragraph or the like, generate the second image including a one dimensional barcode or a two dimensional barcode, based on the data character DC.

Furthermore, as described above, the solution means of the present disclosure has been described as the display apparatus, the display method, and the payment processing system. However, the present disclosure can also be implemented as an aspect including these, and can also be implemented as a program substantially equivalent to these, and a storage medium in which the program is recorded, and it is to be understood that these are included in the scope of the present disclosure.

At least one of the imaging apparatus 1 and the imaging apparatus 4 may include a distance measuring sensor that detects insertion of a product. The distance measuring sensor includes at least one of an infrared sensor and an ultrasonic sensor.

Since the distance measuring sensor detects the insertion of the product, the payment processing system can be operated only at necessary timing. With this configuration, it is possible to achieve power saving of the payment processing system.

The input unit 31 may include a light source for illuminating a bar code reading unit, such as a scanning area of a bar code reader. The light source may be a LD (Laser Diode), but is not limited thereto.

By illuminating the bar code reading unit with the light source, a high-quality image can be acquired even under a low-illuminance environment. In addition, the exposure time of the input unit 31 is shortened.

### REFERENCE SIGNS

1, 4 imaging apparatus
2, 6 display apparatus
3, 7, 10 cash register
5 calculation apparatus
8 object recognition apparatus
11, 41, 81 imaging unit
12, 521 acquisition unit
13, 23, 42, 53, 62, 83, 93 output unit
21, 31, 51, 61, 71, 91 input unit
22, 52, 92 calculation unit
221, 5221 determination unit
222, 5222 correction processing unit
522 display processing unit
32, 72, 102 specification unit
33, 73, 103 payment processing unit

1. A payment processing system comprising:
an imaging device configured to capture a first image that includes an imaging target;
a display configured to:
receive the first image; and
display a second image including identification information of the imaging target; and
a register configured to:
contain an input unit; and
identify the imaging target with the identification information; wherein
the second image is configured to be generated through object recognition processing or correction processing on the first image.

2. The payment processing system according to claim 1, wherein
the identification information includes a one dimensional barcode and a two dimensional barcode.

3. The payment processing system according to claim 1, wherein
the display comprises a calculation unit that is configured to generate the second image.

4. The payment processing system according to claim 3, wherein
the calculation unit is further configured to:
determine whether the first image satisfies a predetermined condition, and
correct the first image when the first image doesn't satisfy the predetermined condition.

5. The payment processing system according to claim 4, wherein
the correction processing includes any one of rotation correction, distortion correction, contrast correction, edge correction, and regeneration correction.

6. A display apparatus comprising:
an input unit configured to receive a first image that includes a imaging target; and
an output unit configured to display a second image that includes identification information of the imaging target, wherein
the second image is configured to be generated through object recognition processing or correction processing on the first image.

7. A display method comprising:
receiving a first image in which an imaging target is captured;
performing object recognition processing or correction processing on the first image;
generating a second image including identification information of the imaging target; and
displaying the second image to an input unit of a cash register.

8. A payment processing system comprising:
an object recognition apparatus configured to identify an imaging target based on a first image;
a display configured to display a second image that includes identification information of the imaging target; and
a register configured to identify the imaging target with the identification information.
